(19) United States
(12) Patent Application Publication
(10) Pub. No.: US 2025/0233896 A1
(43) Pub. Date: Jul. 17, 2025

(54) A SYSTEM FOR GENERATING VOICE, VIDEO AND SHORT MESSAGE CALL RECORDS FROM DATA IN VOLTE ROAMING

(71) Applicant: TURKCELL TEKNOLOJI ARASTIRMA VE GELISTIRME ANONIM SIRKETI, Istanbul (TR)

(72) Inventor: MERT DEVA, ISTANBUL (TR)

(73) Assignee: TURKCELL TEKNOLOJI ARASTIRMA VE GELISTIRME ANONIM SIRKETI, Istanbul (TR)

(21) Appl. No.: 18/723,622

(22) PCT Filed: Dec. 26, 2022
(86) PCT No.: PCT/TR2022/051601

§ 371 Date: Jun. 24, 2024

(30) Foreign Application Priority Data
Dec. 26, 2022 (TR) 2021/021036

(51) Int. Cl. H04L 65/1016; H04M 3/22; H04M 15/00

(52) U.S. Cl. CPC H04L 65/1016; H04M 3/2218; H04M 15/41; H04M 15/57

(57) ABSTRACT

The present invention relates to a system which enables to generate call detail records related to voice and sms voice communications of the said persons upon foreigners-who are roaming—communicate with each other over voice and sms by using VOLTE, and ensures that the data traffic occurring in the network as a result of voice, sms, video-based agreements made with foreigners can be observed by the network.

### TECHNICAL FIELD

The present invention relates to a system which enables to generate call detail records related to voice and sms voice communications of the said persons upon foreigners-who are roaming—communicate with each other over voice and sms by using VOLTE, and ensures that the data traffic occurring in the network as a result of voice, sms, video-based agreements made with foreigners can be observed by the network.

### BACKGROUND OF THE INVENTION

Today, mobile communication is carried out by the standards set by the 3GPP organization. Users can communicate with each other by means of their mobile devices supporting VOLTE feature that realize voice transfer over LTE, with high sound quality. Communication networks charge persons, who communicate over VOLTE, only on a mobile data basis. However, communication networks make agreement with their own subscribers or foreign subscribers—who are roaming—such as minute-based voice, minute-based video and number-based sms. In the current technique, users—who are roaming—are charged only on a mobile data basis when they are charged. In the state of the art, there is no solution which enables to generate call detail records related to voice, video, sms communications realized by persons-who perform VOLTE roaming—between the network wherein they roam and their own local network; to decode communication protocols such as session initiation protocol (SIP), user datagram protocol (UDP), transmission control protocol (TCP) and internet protocol (IP) by means of a function that serves during generation of call detail records of the persons who performs VOLTE roaming; to eliminate the loss of income based on erroneous estimation in agreements between the foreign network and the local network by providing visibility to commercial teams upon call detail records of the persons-who perform VOLTE roaming—are generated from voice, video, sms data.

Due to the abovementioned reasons, there is need for a system for generating voice, video and short message call records from data in VOLTE roaming which enables to generate call detail records related to voice, video, sms communications realized by persons-who perform VOLTE roaming—between the network wherein they roam and their own local network; to decode communication protocols such as session initiation protocol (SIP), user datagram protocol (UDP), transmission control protocol (TCP) and internet protocol (IP) by means of a function that serves during generation of call detail records of the persons who performs VOLTE roaming; to eliminate the loss of income based on erroneous estimation in agreements between the foreign network and the local network by providing visibility to commercial teams upon call detail records of the persons-who perform VOLTE roaming—are generated from voice, video, sms data.

The United States patent document no. US2021227001, an application in the state of the art, discloses a system and method for implementing a VOLTE and circuit switched voice and SMS interworking function to provide voice and SMS service to roaming mobile devices at visiting network based on VOLTE roaming and ‘SMS over SGs’ towards VPLMN, and circuit-switched voice and SMS towards HPLMN. The interworking function enables and redirects IMS traffic at VPLMN towards a hosted IMS core with voice connectivity to PSTN via MGCF and MGW. The interworking function also performs circuit-switched location-update registration at HLR at HPLMN for receiving mobile-terminated voice calls and SMS.

### SUMMARY OF THE INVENTION

The objective of the present invention is to realize a system for generating voice, video and short message call records from data in VOLTE roaming which enables to generate call detail records related to voice, video, sms communications realized by persons-who perform VOLTE roaming—between the network wherein they roam and their own local network; to decode communication protocols such as session initiation protocol (SIP), user datagram protocol (UDP), transmission control protocol (TCP) and internet protocol (IP) by means of a function that serves during generation of call detail records of the persons who performs VOLTE roaming; to eliminate the loss of income based on erroneous estimation in agreements between the foreign network and the local network by providing visibility to commercial teams upon call detail records of the persons—who perform VOLTE roaming—are generated from voice, video, sms data.

### DETAILED DESCRIPTION OF THE INVENTION

The “System for Generating Voice, Video and Short Message Call Records from Data in VOLTE Roaming” realized to fulfil the objective of the present invention is shown in the figure attached, in which:

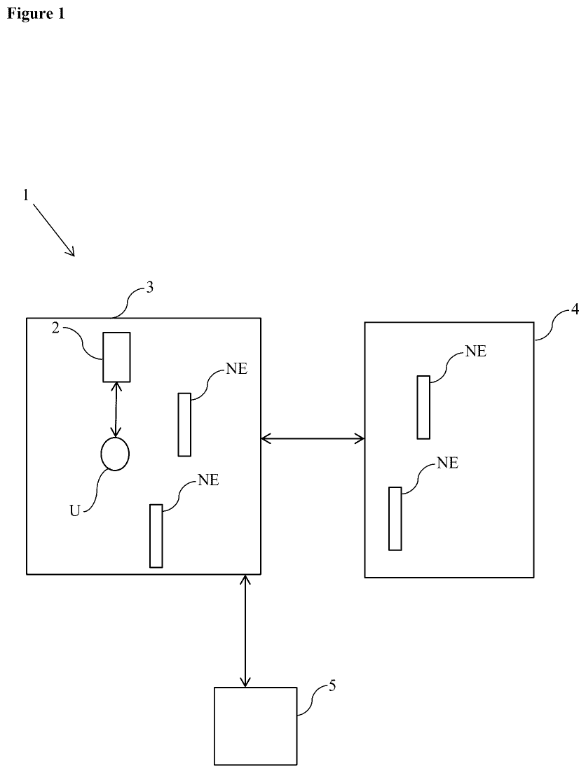

FIG. 1 is a schematic view of the inventive system for generating voice, video and short message call records from data in VOLTE roaming.

The components illustrated in the figure are individually numbered, where the numbers refer to the following:
1. System
2. Electronic device
3. Visited public land mobile network
4. Local public land mobile network
5. Server
U. User
NE. Network element

The inventive system (1) for generating voice, video and short message call records from data in VOLTE roaming which enables to generate call detail records related to voice and sms voice communications of the said persons upon foreigners-who are roaming—communicate with each other over voice and sms by using VOLTE, and ensures that the data traffic occurring in the network as a result of voice, sms, video-based agreements made with foreigners can be observed by the network, comprises:
at least one electronic device (2) which is configured to enable the user (U) to communicate with other persons over at least one communicate network;
at least one visited public land mobile network (3) which is configured to enable the user (U) to communicate with other persons by ensuring that s/he can roam in another region by his/her own local SIM card, and has a plurality of network elements (NE);
at least one local public land mobile network (4) which is configured to terminate the roaming data such as voice, video, sms—that arise from the visited public land mobile network (3) including the communication network whereto the user (U) is a subscriber-on itself and has a plurality of network elements (NE);
at least one server (5) which is included in the visited public land mobile network (3) and is configured to generate call detail records of voice data, call detail records of video data and detail records of sms data by using the voice, video, sms data traffic information of the user (U) upon running the roaming data—that occurs from the visited public land mobile network (3) towards the local public land mobile network (4) by the roaming electronic device (2)—by means of a production function of voice call detail record on itself; and to ensure that the call detail records of the roaming user (U) generated related to his/her electronic device (2) remain in the visited public land mobile network (3).

The electronic device (2) included in the inventive system (1) is a smart device such as mobile phone, tablet, computer configured to enable the user (U) to initiate a call towards the visited public land mobile network (3) over VOLTE, to send sms or to send video by ensuring that s/he roams on the visited public land mobile network (3). The electronic device (2) is configured to send invitation message to the IMS subnetwork in the local public land mobile network (4) when initiating a call from the visited public land mobile network (3) towards the local public land mobile network (4). The electronic device (2) is configured to transmit session initiation protocol (SIP) message to the IMS subnetwork in the local public land mobile network (4) at the step of sending sms from the visited public land mobile network (3) towards the local public land mobile network (4).

The visited public land mobile network (3) included in the inventive system (1) is configured to provide 4G radio access to the electronic device (2) by means of at least one network element (NE) of eNodeB type; ensure that data traffic of the roaming electronic device (2) is managed by means of at least one network element (NE) of service gateway (SGW) type located on itself; ensure that call detail records are directed to subsystems by enabling the incoming call detail records to be formatted by means of at least one mediation system located on itself; ensure that roaming agreements are made with the wholesale teams located on itself and data usage is calculated over summary data; ensure that information of the electronic device (2) for using the visited public land mobile network (3) is requested from every foreign country operator by means of the regulatory authority located on itself; ensure that intermediate signalling and intermediate data realized by the local public land mobile network (4) are carried by means of the network element (NE) in the form of IPX on itself and the number of connections is reduced by allowing to establish connection with the local public land mobile network (4) directly; ensure that network selection and mobility management transactions of subscribers are carried out by the network element (NE) of MME type located on itself and descriptions enabling the subscriber to perform VOLTE roaming are stored; ensure that the network element (NE) of service gateway type can provide service on the signalling side in the CUPS architecture by means of the network element (NE) of SGW-C type on itself.

The visited public land mobile network (3) included in the inventive system (1) is configured to ensure that the GTP tunnel is terminated by means of the network element (NE) in the form of packet gateway (PGW) located on itself and to direct the IMS traffic to the IMS network; and ensure that SIP signalling is carried out at the entrance of the IMS network by means of the network element (NE) in the form of session border controller (SBC) located on itself.

The server (5) included in the inventive system (1) is configured to access data such as calling party, called party in the call, device identity number (IMEI), information of cell where the call is made by establishing connection with the network element (NE) in the form of service gateway (SGW) on the visited public land mobile network (3), by analysing the invitation message transmitted from the electronic device (2) to the IMS subnetwork in the local public land mobile network (4); to detect that the call has started ringing by the ringing message transmitted to the electronic device (2); to detect that the call is completed by means of the “bye” message transmitted from the electronic device (2) to the IMS subnetwork in the local public land mobile network (4). The server (5) is configured to generate call detail records of voice and video data related to the electronic device (2) in VOLTE roaming by using the calling party information, the called party information, the information of device identity number, the information of cell where the call is made, the information of ringing message, the information of “bye” message it accessed; to use the sender, addressee, sms centre, sending time, message size information in the session initiation protocol message when generating the call detail records from the sms data related to the electronic device (2) in VOLTE roaming. The server (5) is configured to generate the call detail records of the said electronic device (2) by using the voice, video and sms data on the side of the network element (NE) of SGW-U type terminating the GTP-U tunnel when it determines that the network element (NE) in the form of service gateway uses the CUPS architecture in the visited public land mobile network (3) while it generates the call detail records of the electronic device (2) in VOLTE roaming.

### Industrial Applicability of the Invention

In the inventive system (1), the user (U) initiates a call towards the local public land mobile network (4) by performing VOLTE roaming on the visited public land mobile network (3) by using his/her electronic device (2). The server (5) analyses the voice, video and sms data related to the electronic device (2) by establishing connection with the network element (NE) in the form of service gateway (SGW) in the visited public land mobile network (3) and generates the data of voice call detail record, video call detail record and sms call detail record according to the information of voice, video and sms data traffic of the said electronic device (2). Thereby, it is ensured that loss of income based on erroneous estimation in agreements between the foreign network (VPLMN) and the local network (HPLMN) is eliminated.

With the inventive system (1), it is ensured that call detail records related to voice, video, sms communications realized by persons-who perform VOLTE roaming—between the network wherein they roam and their own local network are generated; communication protocols such as session initiation protocol (SIP), user datagram protocol (UDP), transmission control protocol (TCP) and internet protocol (IP) are decoded by means of a function that serves during generation of call detail records of the persons who performs VOLTE roaming; the loss of income based on erroneous estimation in agreements between the foreign network and the local network is eliminated by providing visibility to commercial teams upon call detail records of the persons-who perform VOLTE roaming—are generated from voice, video, sms data.

The server (5) included in the inventive system (1) submit information and approval to the user in accordance with the principles of data privacy and they operate within the scope of the Law on Protection of Personal Data (KVKK).

Within these basic concepts; it is possible to develop a wide variety of embodiments of the inventive system (1) for generating voice, video and short message call records from data in VOLTE roaming; the invention cannot be limited to examples disclosed herein and it is essentially according to claims.

1. A system (1) for generating voice, video and short message call records from data in VOLTE roaming which enables to generate call detail records related to voice and sms voice communications of the said persons upon foreigners-who are roaming—communicate with each other over voice and sms by using VOLTE, and ensures that the data traffic occurring in the network as a result of voice, sms, video-based agreements made with foreigners can be observed by the network, comprising
at least one electronic device (2) which is configured to enable the user (U) to communicate with other persons over at least one communicate network;
at least one visited public land mobile network (3) which is configured to enable the user (U) to communicate with other persons by ensuring that s/he can roam in another region by his/her own local SIM card, and has a plurality of network elements (NE);
at least one local public land mobile network (4) which is configured to terminate the roaming data such as voice, video, sms—that arise from the visited public land mobile network (3) including the communication network whereto the user (U) is a subscriber-on itself and has a plurality of network elements (NE);
and characterized by
at least one server (5) which is included in the visited public land mobile network (3) and is configured to generate call detail records of voice data, call detail records of video data and detail records of sms data by using the voice, video, sms data traffic information of the user (U) upon running the roaming data—that occurs from the visited public land mobile network (3) towards the local public land mobile network (4) by the roaming electronic device (2)—by means of a production function of voice call detail record on itself;
and to ensure that the call detail records of the roaming user (U) generated related to his/her electronic device (2) remain in the visited public land mobile network (3).

2. A system (1) for generating voice, video and short message call records from data in VOLTE roaming according to claim 1; characterized by the electronic device (2) which is a smart device such as mobile phone, tablet, computer configured to enable the user (U) to initiate a call towards the visited public land mobile network (3) over VOLTE, to send sms or to send video by ensuring that s/he roams on the visited public land mobile network (3).

3. A system (1) for generating voice, video and short message call records from data in VOLTE roaming according to claim 1; characterized by the electronic device (2) which is configured to send invitation message to the IMS subnetwork in the local public land mobile network (4) when initiating a call from the visited public land mobile network (3) towards the local public land mobile network (4).

4. A system (1) for generating voice, video and short message call records from data in VOLTE roaming according to claim 1, characterized by the electronic device (2) which is configured to transmit session initiation protocol (SIP) message to the IMS subnetwork in the local public land mobile network (4) at the step of sending sms from the visited public land mobile network (3) towards the local public land mobile network (4).

5. A system (1) for generating voice, video and short message call records from data in VOLTE roaming according to claim 1, characterized by the visited public land mobile network (3) which is configured to provide 4G radio access to the electronic device (2) by means of at least one network element (NE) of eNodeB type; ensure that data traffic of the roaming electronic device (2) is managed by means of at least one network element (NE) of service gateway (SGW) type located on itself; ensure that call detail records are directed to subsystems by enabling the incoming call detail records to be formatted by means of at least one mediation system located on itself; ensure that roaming agreements are made with the wholesale teams located on itself and data usage is calculated over summary data; ensure that information of the electronic device (2) for using the visited public land mobile network (3) is requested from every foreign country operator by means of the regulatory authority located on itself; ensure that intermediate signalling and intermediate data realized by the local public land mobile network (4) are carried by means of the network element (NE) in the form of IPX on itself and the number of connections is reduced by allowing to establish connection with the local public land mobile network (4) directly; ensure that network selection and mobility management transactions of subscribers are carried out by means of the network element (NE) of MME type located on itself and descriptions enabling the subscriber to perform VOLTE roaming are stored; ensure that the network element (NE) of service gateway type can provide service on the signalling side in the CUPS architecture by means of the network element (NE) of SGW—C type on itself.

6. A system (1) for generating voice, video and short message call records from data in VOLTE roaming according to claim 1, characterized by the visited public land mobile network (3) which is configured to ensure that the GTP tunnel is terminated by means of the network element (NE) in the form of packet gateway (PGW) located on itself and to direct the IMS traffic to the IMS network; and ensure that SIP signalling is carried out at the entrance of the IMS network by means of the network element (NE) in the form of session border controller (SBC) located on itself.

7. A system (1) for generating voice, video and short message call records from data in VOLTE roaming according to claim 1, characterized by the server (5) which is configured to access data such as calling party, called party in the call, device identity number (IMEI), information of cell where the call is made by establishing connection with the network element (NE) in the form of service gateway (SGW) on the visited public land mobile network (3), by analysing the invitation message transmitted from the electronic device (2) to the IMS subnetwork in the local public land mobile network (4); to detect that the call has started ringing by the ringing message transmitted to the electronic device (2); to detect that the call is completed by means of the “bye” message transmitted from the electronic device (2) to the IMS subnetwork in the local public land mobile network (4).

8. A system (1) for generating voice, video and short message call records from data in VOLTE roaming according to claim 1, characterized by the server (5) which is configured to generate call detail records of voice and video data related to the electronic device (2) in VOLTE roaming by using the calling party information, the called party information, the information of device identity number, the information of cell where the call is made, the information of ringing message, the information of “bye” message it accessed; to use the sender, addressee, sms centre, sending time, message size information in the session initiation protocol message when generating the call detail records from the sms data related to the electronic device (2) in VOLTE roaming.

9. A system (1) for generating voice, video and short message call records from data in VOLTE roaming according to claim 1, characterized by the server (5) which is configured to generate the call detail records of the said electronic device (2) by using the voice, video and sms data on the side of the network element (NE) of SGW-U type terminating the GTP-U tunnel when it determines that the network element (NE) in the form of service gateway uses the CUPS architecture in the visited public land mobile network (3) while it generates the call detail records of the electronic device (2) in VOLTE roaming.
